(19) United States
(12) Patent Application Publication
(10) Pub. No.: US 2007/0174772 A1
(43) Pub. Date: Jul. 26, 2007

(54) Method and system for integrated network multimedia distribution

(76) Inventor: Jerome S. Gorman, Farmingdale, NJ (US)

Correspondence Address: KENYON & KENYON LLP, ONE BROADWAY, NEW YORK, NY, 10004, US

(21) Appl. No.: 11/332,063

(22) Filed: Jan. 12, 2006

(51) Int. Cl. G06F 3/00

(52) U.S. Cl. 715/716

(57) ABSTRACT

A method, system and apparatus for network audio distribution may be provided. The method may include providing a list of characteristics for an audio file to be created to a creator. The method may also include receiving a text of the audio file from the creator. The method may also include receiving an indication of a selection of characteristics for the audio file from the creator, where the selection of characteristics is selected from the list of characteristics. The method may also include transmitting the text and the selection of characteristics to a producer.

### BACKGROUND

Podcasting is a method of distribution audio and video via the Internet. Typically, subscribers subscribe to a number of podshows or subscriptions, and then hear or view the material when they choose. Each podshow includes one or more audio files. For example, a podshow may include audio files in the MP3 format. The audio files may be produced regularly. As a new audio file is produced, it is stored on a server which makes the new audio file available to all the subscribers of the podshow associated with the new audio file.

Podcasting often utilizes a subscription model, unlike other forms of online one-time media delivery. This makes podcasting well suited to information that needs to be regularly updated, such as news or sports.

### BRIEF DESCRIPTION OF THE DRAWINGS

FIG. 1A illustrates a first example system for integrated network multimedia distribution, in accordance with an example embodiment of the present invention.

FIG. 1B illustrates a second example system for integrated network multimedia distribution, in accordance with an example embodiment of the present invention.

FIG. 2A illustrates an example procedure to log in a user, in accordance with an example embodiment of the present invention.

FIG. 2B illustrates an example procedure for a creator to produce a podshow, in accordance with an example embodiment of the present invention.

FIG. 2C illustrates an example procedure for a creator to publish a podshow, in accordance with an example embodiment of the present invention.

FIG. 2D illustrates an example procedure for a producer to create an audio file, in accordance with an example embodiment of the present invention.

FIG. 2E illustrates a first example procedure for an advertiser to publish an advertiser-audio file for advertisement through advertiser-inputted criteria, in accordance with an example embodiment of the present invention.

FIG. 2F illustrates a second example procedure for an advertiser to publish an advertiser-audio file for advertisement through a bidding process, in accordance with an example embodiment of the present invention.

FIG. 3A illustrates an example screen shot of a log in screen, in accordance with an example embodiment of the present invention.

FIG. 3B illustrates an example screen shot of a registration screen, in accordance with an example embodiment of the present invention.

FIG. 3C illustrates an example screen shot of a main menu screen, in accordance with an example embodiment of the present invention.

FIG. 3D illustrates an example screen shot of a first screen of producing a podshow process, in accordance with an example embodiment of the present invention.

FIG. 3E illustrates an example screen shot of a second screen of producing a podshow process, in accordance with an example embodiment of the present invention.

FIG. 3F illustrates an example screen shot of a third screen of producing a podshow process, in accordance with an example embodiment of the present invention.

FIG. 3G illustrates an example screen shot of a first screen of publishing a podshow process, in accordance with an example embodiment of the present invention.

FIG. 3I illustrates an example screen shot of a second screen of publishing a podshow process, in accordance with an example embodiment of the present invention.

FIG. 3J illustrates an example screen shot of a second screen of publishing a podshow process, in accordance with an example embodiment of the present invention.

FIG. 3K illustrates an example screen shot of a third screen of publishing a podshow process, in accordance with an example embodiment of the present invention.

FIG. 3L illustrates an example screen shot of a fourth screen of publishing a podshow process, in accordance with an example embodiment of the present invention.

FIG. 3M illustrates an example screen shot of a fourth screen of publishing a podshow process, in accordance with an example embodiment of the present invention.

FIG. 3N illustrates an example screen shot of a fifth screen of publishing a podshow process, in accordance with an example embodiment of the present invention.

FIG. 3O illustrates an example screen shot of a confirmation screen of publishing a podshow process, in accordance with an example embodiment of the present invention.

### DETAILED DESCRIPTION

The present invention may streamline the process for creators to create and publish an audio file as part of, e.g., a podshow. A creator may submit a text and desired characteristics of an audio file and receive back a professionally recorded audio file. The creator may then publish the audio file over the Internet as part of the podshow. The present invention may also streamline the process for producers to receive a text and desired characteristics of an audio file to be professionally recorded. The producer may create the audio file and make it available to the creator. The present invention may also streamline the process for advertisers to create an advertising segment and select an audio file to include the advertising segment with.

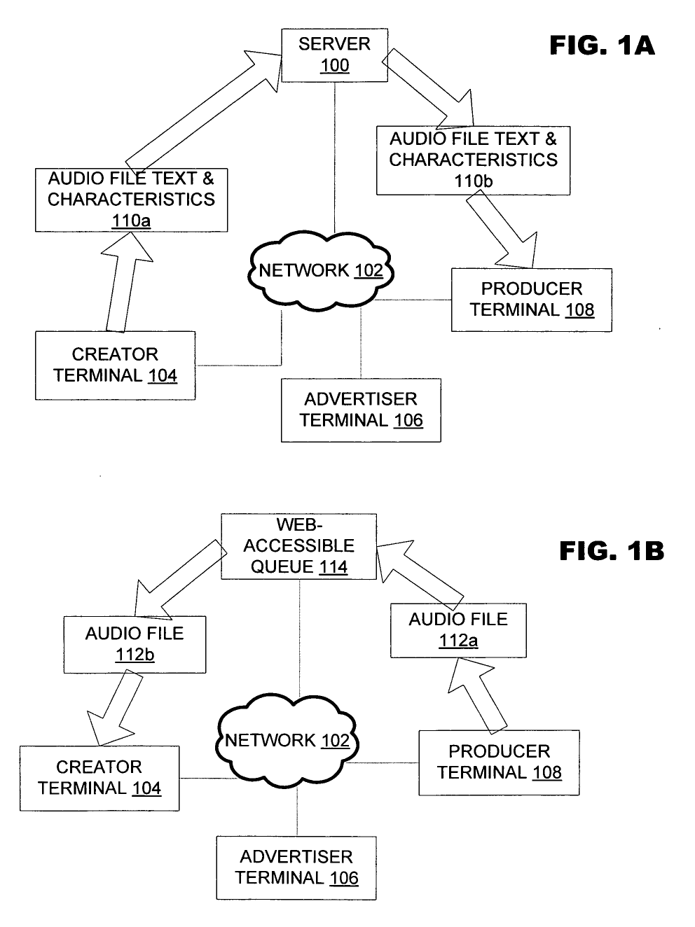

FIG. 1A illustrates a first example system for integrated network multimedia distribution, in accordance with an example embodiment of the present invention. The system may include one or more servers 100. The server 100 may be configured to execute server applications. For example, server applications may include a web server, a database, a firewall, or any other applications. For example, the server 100 may be a server computer with a network interface.

The system may include a network 102. The network 102 may carry communications between different portions of the network 102. For example, the network 102 may be the Internet, a Virtual Private Network (VPN), a Wide Area Network (WPN), or another conventional network. The network 102 may be connected to the server 100, the creator terminal 104, the advertiser terminal 106 and the producer terminal 108. For example, the system may be configured to encrypt communications sent over the network 102.

The system may include one or more creator terminals 104. The creator terminal 104 may be configured to allow a creator to access the server 100 over the network 102 and create an audio file. The creator terminal 104 may be connected to the network 102 and be configured to execute a network browser. For example, the network browser may be Internet Explorer or Netscape Navigator. For example, the creator terminal 104 may be a personal computer (PC), a personal digital assistant (PDA), a wireless device such as a cell phone, or another computing device.

The system may include one or more advertiser terminals 106. The advertiser terminal 106 may be configured to allow an advertiser to access the server 100 over the network 102. The advertiser terminal 106 may be, for example, similar to the creator terminal 104.

The system may include one or more producer terminals 108. The producer terminal 108 may be configured to allow a producer to access the server 100 over the network 102. The producer terminal 108 may be configured produce an audio file. For example, the producer terminal 108 may include an audio microphone and sound recording software. The producer terminal 108 may be, for example, similar to the creator terminal 104.

In accordance with an embodiment of the present invention, an audio file text and characteristics 110a is provided. The audio file text and characteristics 110a may include text of an audio file to be produced and a list of characteristics of the audio file text. For example, characteristics of the audio file may include a reading style (e.g., soft sell, humorous, dramatic, etc.), a voice gender (male or female), and a language (e.g., English, Spanish, etc.) for the audio file. In one embodiment, the audio file text and characteristics 110a may be inputted by a creator at the creator terminal 104. The audio file text and characteristics 110a may then be transmitted to the server 100 through the network 102. The server may receive and store the audio file text and characteristics 110a.

The server 100 may send audio file text and characteristics 110b to one or more producer terminals 108 through the network 102 via, e.g., an email or other suitable means. In one example embodiment, the server 100 selects which of the one or more producers to send the audio file text and characteristics 110b based at least in part on some of the characteristics therein. For example, if the voice gender is “female,” the audio file text and characteristics 110b may be sent to a producer who can produce a female voice.

The audio file text and characteristics 110b may have the same content as the audio file text and characteristics 110a, or may have been processed by the server 100.

In operation, after receiving the audio file text and characteristics 110b, a producer at the producer terminal 108 may read into the audio microphone the audio file text in accordance with the associated characteristics. For example, if the characteristics indicate “female” and “humorous,” the producer may read the audio file text into the audio microphone with a female voice and in a humorous style. The sound recording software may be utilized to record and store the audio in an audio file, e.g., in MP3 format. In one embodiment, the producer may read the text several times and create multiple versions of the audio file to allow, e.g., the creator to choose one or more of the versions.

FIG. 1B illustrates a second example system for integrated network multimedia distribution, in accordance with an example embodiment of the present invention. For example, the system may be similar to the first system depicted in FIG. 1A. The system depicts the transfer of one or more audio files after it is produced.

The system may include one or more audio files 112a. The audio files 112a may be created at the producer terminal 108 in response to information received from the creator terminal 104. The audio files 112a may be a digital file representing an audio segment. The audio files 112a may be, for example, an MP3 file or another conventional format.

The system may include a web-accessible queue 114. The web-accessible queue 114 may be configured to receive and store the audio files 112a.

The web-accessible queue 114 provides a means for a creator at creator terminal 104 to access the audio files 112a. For example, the web-accessible queue 114 may be a web-server configured to store and transmit audio files, or the web-accessible queue 114 may be configured to allow a creator at the creator terminal 104 to retrieve audio files from storage. Creators and producers may have individual user accounts. In operation, a producer may be able to transmit and store the audio files 112a on the web-accessible queue 114. A creator may be able to retrieve the audio files 112b from (or via) the web-accessible queue 114.

Alternatively, the web-accessible queue 114 may be a conventional file server accessible from the network 102. For example, if the network 102 is the Internet, the web-accessible queue may instead be a conventional File Transfer Protocol (FTP) server. Alternatively, the web-accessible queue 114 may be a conventional email system, where the producer terminal 108 emails the audio files 112a directly to the creator at creator terminal 104.

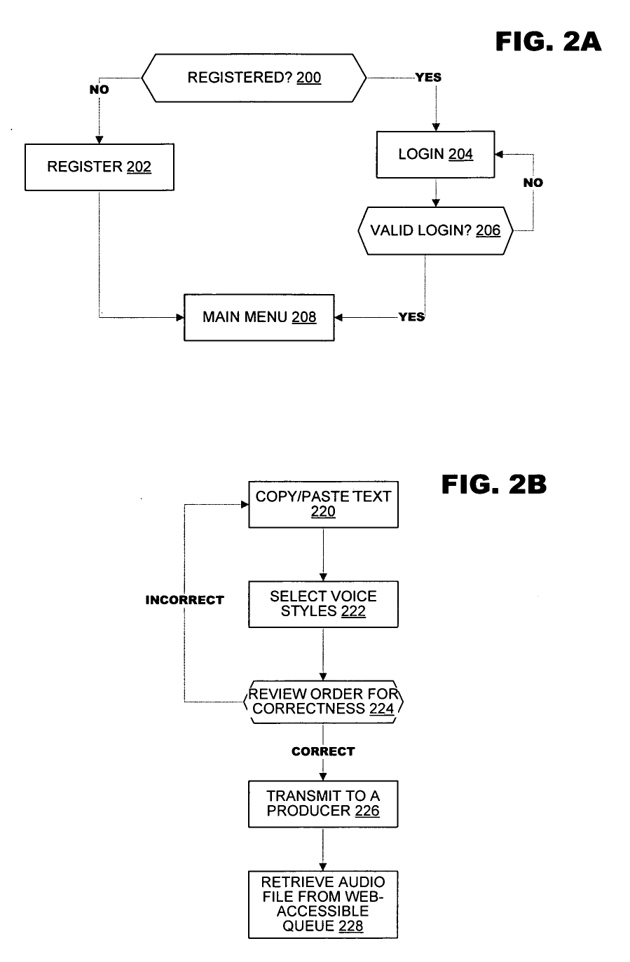

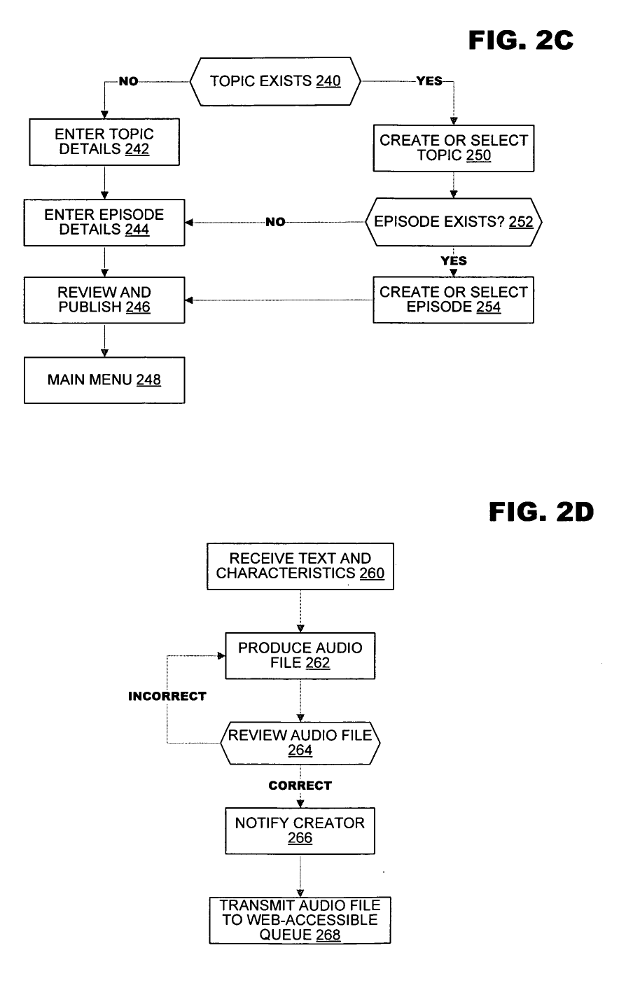

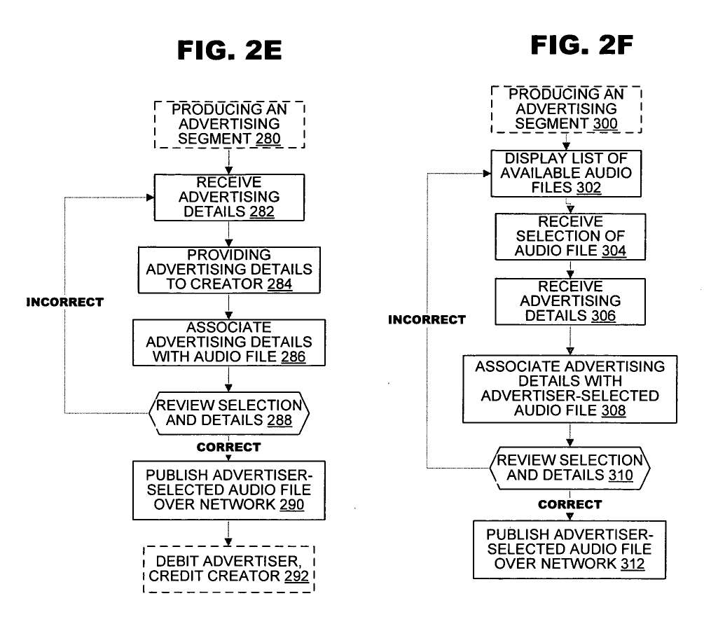

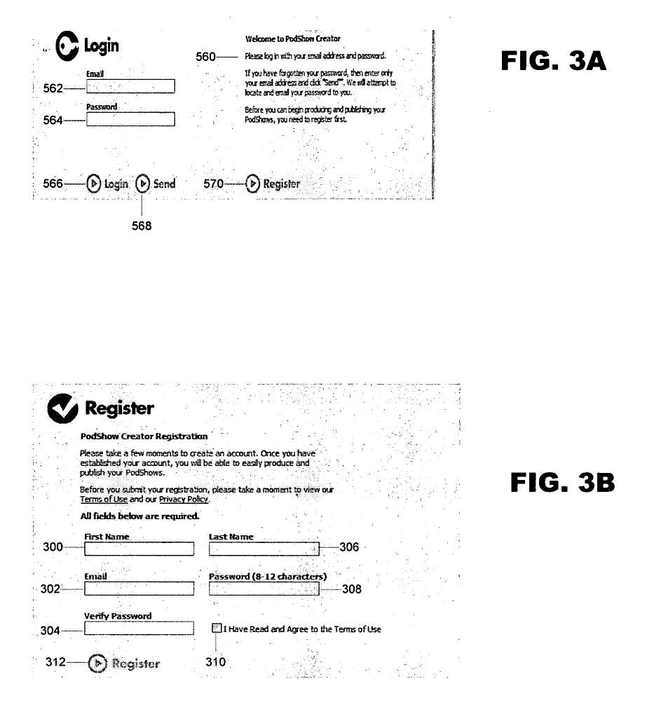

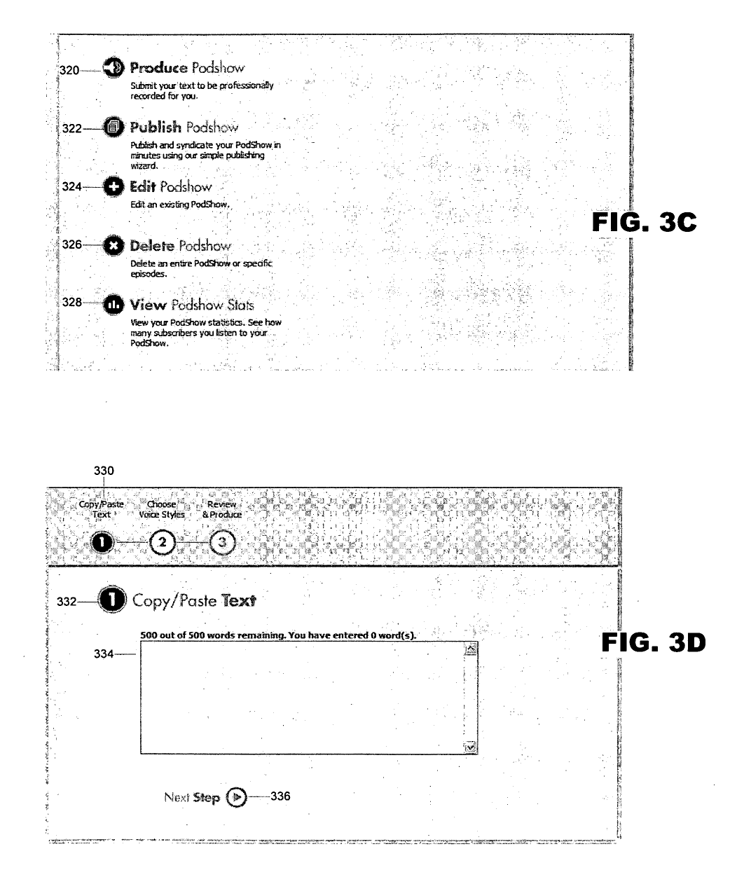

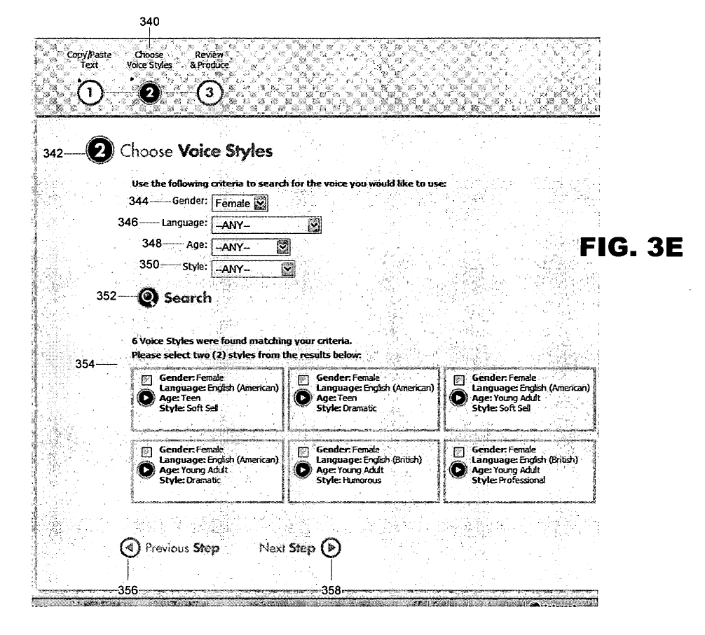

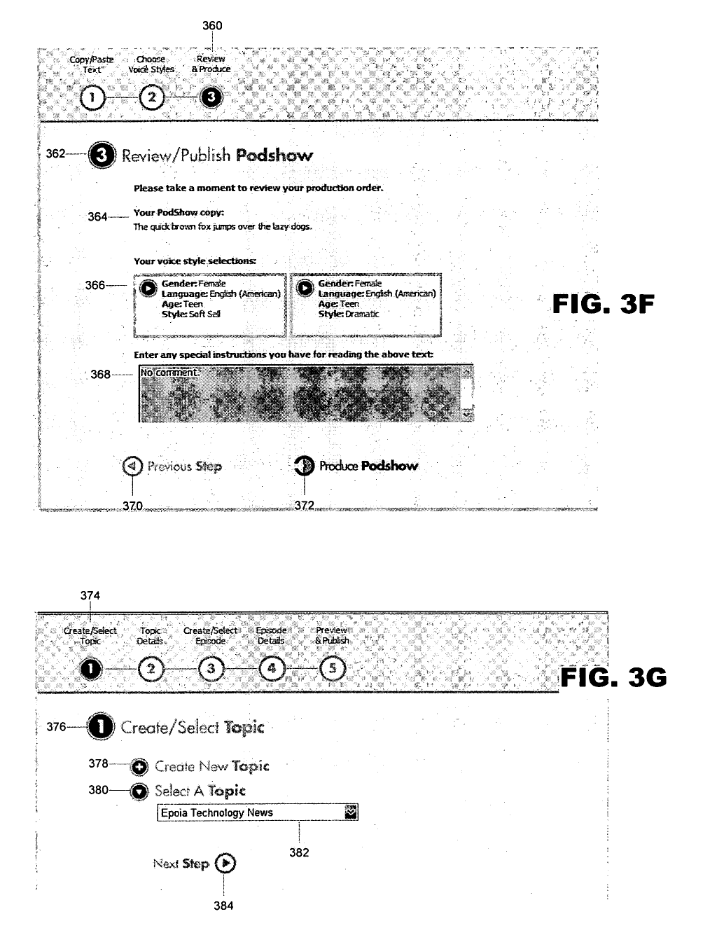

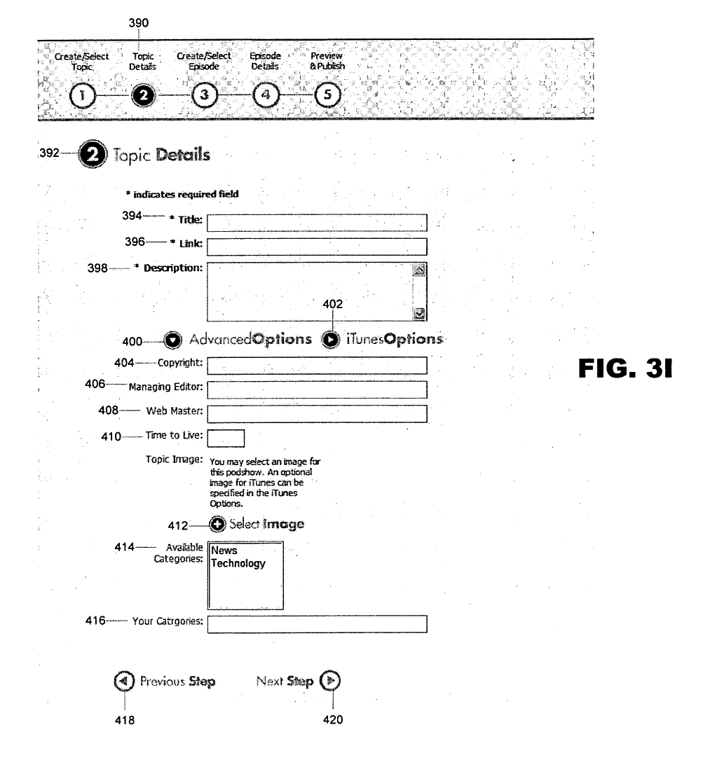

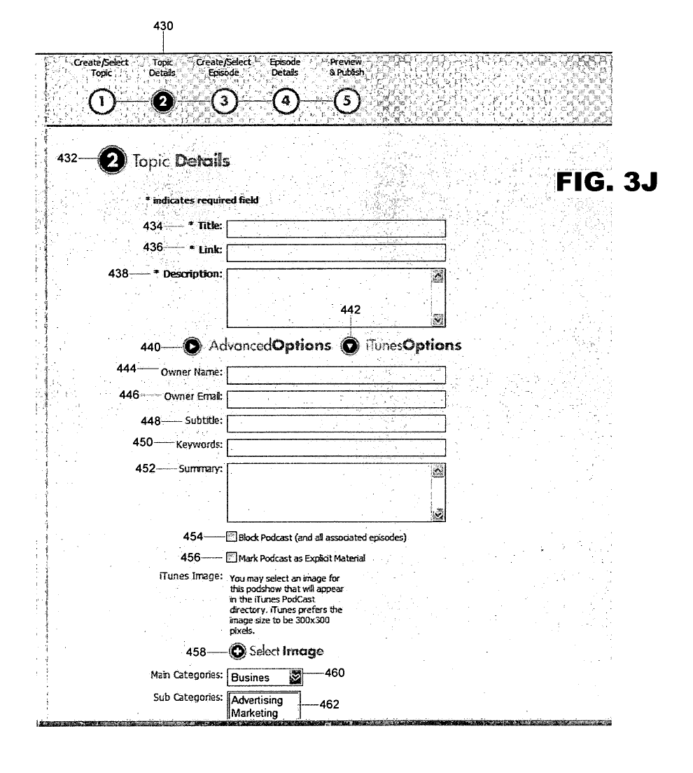

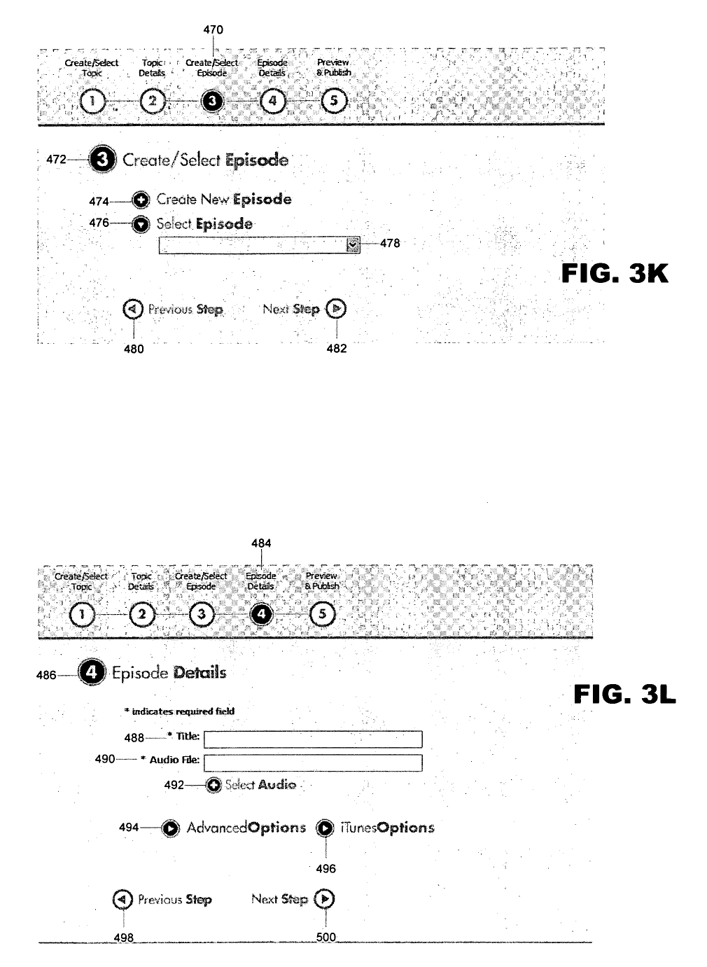

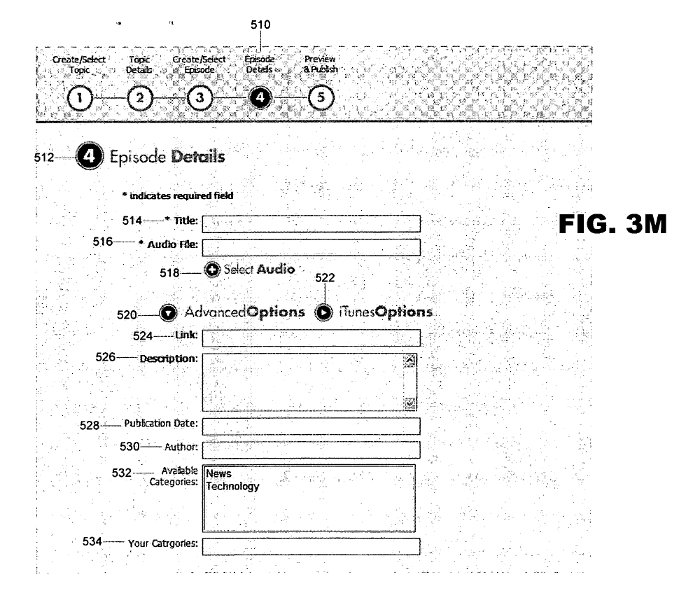

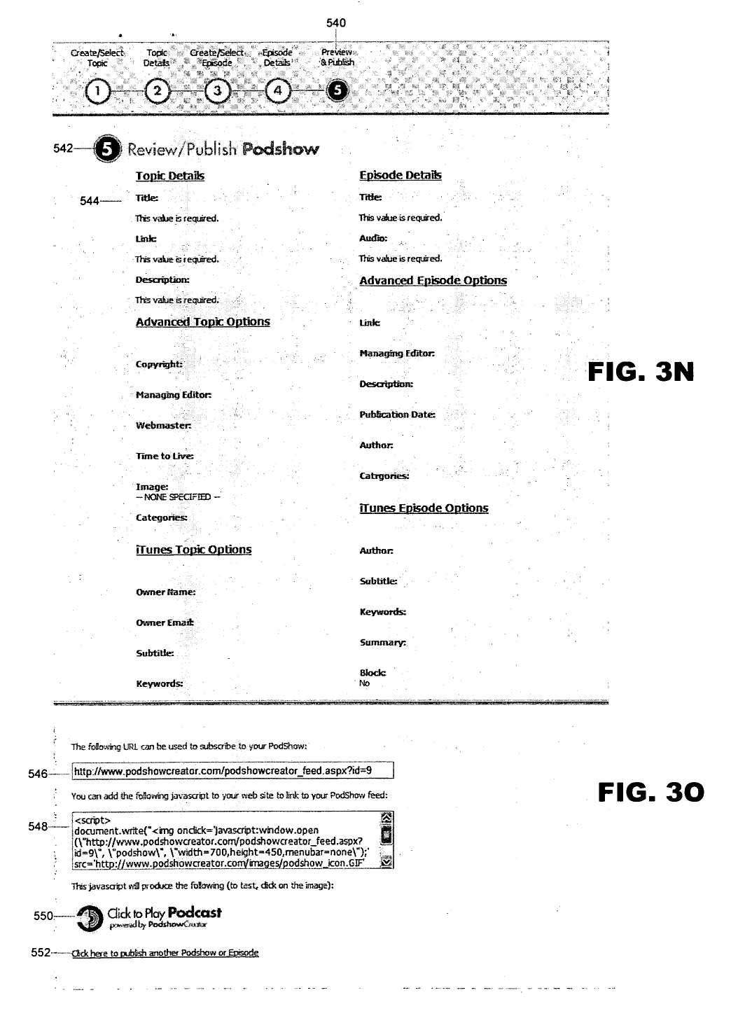

FIG. 2A illustrates an example procedure to log in a user, in accordance with an example embodiment of the present invention. The procedure may occur on a server in communication with a creator terminal, as depicted in FIG. 1A. In 200, the server may test whether a user is already registered. For example, the server may ask whether the user has an existing account. If yes, the procedure may proceed to 204. If no, the procedure may proceed to 202. For example, 200 may be implemented with a screen as depicted in FIG. 3A.

In 202, a user may input information to create an account on the server. For example, 202 may be implemented with a screen as depicted in FIG. 3B.

In 204, a user may input a login information. For example, the login information may include a username and password. For example, 204 may be implemented with a screen as depicted in FIG. 3A.

In 206, the server may verify the login information submitted in 204. For example, the server may access a database of all existing login information to verify the login formation submitted in 204 is correct. If the login information is correct, the procedure may proceed to 208. If the login information is incorrect, the procedure may return to 204 and allow the user another chance to input his login information.

In 208, a main menu may be displayed. For example, the main menu may be as depicted in FIG. 3C.

FIG. 2B illustrates an example procedure for a creator to produce an audio file, e.g., for a podshow, in accordance with an example embodiment of the present invention. The procedure may occur on a server in communication with a creator terminal, as depicted in FIG. 1A. In 220, a creator may provide text to be read by a producer to create an audio file. For example, 220 may be implemented with a screen as depicted in FIG. 3D.

In 222, the creator may select voice styles and other characteristics to be associated with the created audio file. Other characteristics may include a reading style, a voice gender, and a language of the audio file. For example, 222 may be implemented with a screen as depicted in FIG. 3E.

In 224, the creator may be asked to review the order. For example, 224 may be implemented with a screen as depicted in FIG. 3F. If the creator agrees the order is correct, the procedure may proceed to 226. If the creator indicates the order is not correct, the procedure may proceed to 220 where a new text may be inputted.

In 226, the server may transmit the text received in 220 and the voice styles received in 222 to a producer. The producer may then produce an audio file corresponding to the text and voice styles. The producer may then store the audio file on a web-accessible queue.

In 228, the creator may retrieve the audio file from the web-accessible queue to the creator terminal as depicted in FIG. 1B. Alternatively, the creator may retrieve multiple audio files

FIG. 2C illustrates an example procedure for a creator to publish a podshow, in accordance with an example embodiment of the present invention. The procedure may occur on a server in communication with a creator terminal, as depicted in FIG. 1A. In 240, a server may test whether a topic exists. If a topic exists, the procedure may proceed to 250. If no topics exist, the procedure may proceed to 242. For example, 242 may be executed when there are no previously existing topics or episodes.

In 242, a user may enter details for a new topic. For example, 242 may be implemented with a screen as depicted in FIGS. 3I and 3J.

In 244, a user may enter details for a new episode. For example, 244 may be implemented with a screen as depicted in FIG. 3M.

In 246, the server may display the current topic and episode information for the user's review. For example, 246 may be implemented in a screen as depicted in FIG. 3N. In addition, the server may also display linking information for the published audio file. For example, linking information may be displayed on a screen as depicted in FIG. 3O.

In 248, the procedure may display a main menu. For example, the main menu may be as displayed in FIG. 3C.

In 250, a user may have a choice of creating a new topic or selecting an existing topic. For example, 250 may be implemented with a screen as depicted in FIG. 3G. The existing topics may be stored in a database accessible to the server.

In 252, the server may test whether there are existing episodes. If yes, the procedure may proceed to 254. If no, the procedure may proceed to 246.

In 254, the user may have a choice of creating a new episode or selecting an existing episode. For example, 254 may be implemented with a screen as depicted in FIG. 3K.

FIG. 2D illustrates an example procedure for a producer to create an audio file, in accordance with an example embodiment of the present invention. In 260, information including a text and characteristics may be received. For example, the characteristics may include characteristics and voice styles of the audio file to be created. For example, the information may be received at a producer terminal from the server as depicted in FIG. 1A.

In 262, the producer may review the received text and characteristics and record an audio file. For example, the producer terminal may include a microphone and recording software. In this example embodiment, the producer will record a reading of the text with the requested characteristics. Alternatively, the producer may produce multiple audio files.

In 264, the producer may review the audio file for correctness. If the audio file is correct, the procedure may proceed to 266. If the audio file is incorrect, the producer may produce a replacement audio file in 262.

In 266, the producer may notify the creator that the audio file has been created. For example, the producer may send an email to the creator. Alternatively, the producer may notify the server, and the server may send an email to the creator.

In 268, the producer may transmit the audio file to a web-accessible queue. For example, the web-accessible queue may be as described in FIG. 1B. The audio file may be stored on the web-accessible queue for the creator to retrieve.

FIG. 2E illustrates a first example procedure for an advertiser to publish an advertiser-audio file for advertisement through advertiser-inputted criteria, in accordance with an example embodiment of the present invention. The procedure may occur on a server in communication with an advertiser terminal as depicted in FIGS. 1A and 1B. In 280, the advertiser may optionally produce an advertising segment. The advertising segment may be an audio file. The advertising segment may be produced in a procedure similar to the procedure depicted in FIGS. 2B and 2D.

In 282, the server may receive advertising details from the advertiser. For example, advertising details may include details about the advertising segment and the product or service being advertised. The advertising details may also include criteria that the advertiser requires in a podshow. For example, the advertiser may require that a podshow have a specified number of subscribers or discusses a specified topic.

In 284, the server may provide the advertising details to the creator. The creator may decide to accept the advertiser's advertising segment to be associated with an audio file created by the creator.

In 286, the advertising details may be associated with the audio file selected by the creator.

In 288, the audio file, the advertising details and the advertising segment may be reviewed by the advertiser. This review may occur at a subsequent session from 282.

In 290, the server may publish the audio file along with the advertising segment over the network. For example, the audio file may be published via a Really Simple Syndication (RSS) 2.0 or Atom protocol. For example, publication may involve storing the audio file on the server, associating the audio file with a subscription, and sending the audio file out to subscribers associated with the subscription. Subscribers may subscribe to subscriptions, each subscriptions associated with at least one audio file and updated.

In 292, an account associated with the advertiser may optionally be debited a first specified amount of credits. An account associated with the creator may optionally be credited a second specified amount of credits. The credits may be a currency exchangeable for legal tender or other consideration.

For example, the advertiser may be able to update or modify the advertising segment after it has been published. Updating or modifying the advertising segment may incur a new debit and credit transaction. For example, the advertisement segment may only be published with the audio file until an expiration condition is met. For example, an expiration condition may be a specified number of downloads or a specified period of time. Once the expiration condition is met, the advertising segment may be replaced by a second advertising segment. For example, the second advertising segment may be created by the advertiser or a second advertiser. For example, the systems depicted in FIGS. 1A and 1B may be configured to track a number downloads or requests of an audio file. For example, the number of downloads or requests of the audio file may be a factor in determining the debit and credit transaction.

FIG. 2F illustrates a second example procedure for an advertiser to publish an advertiser-audio file for advertisement through a bidding process, in accordance with an example embodiment of the present invention. The procedure may occur on a server in communication with an advertiser terminal as depicted in FIGS. 1A and 1B. In 300, the advertiser may optionally produce an advertising segment. The advertising segment may be an audio file. The advertising segment may be produced in a procedure similar to the procedure depicted in FIGS. 2B and 2D.

In 302, a list of available audio files may be displayed to the advertiser on the advertiser terminal. For example, available audio files may be audio files previously produced on the server by creators that have not yet been associated with an advertising segment.

In 304, the advertiser may select an advertiser-selected audio file and transmit the selection to the server.

In 306, the advertiser may transmit advertising details. For example, advertising details may include details about the advertising segment and the product or service being advertised. The advertising details may also include an advertising segment title and a bid price.

Alternatively, the advertising details may include an advertising segment title and a purchase price. A purchase price may be previously determined.

In 308, the server may select a set of advertising details with a highest bid price. Alternatively, the server may select the set of advertising details that include the purchase price. The server may associate the set of advertising details with the advertiser-selected audio file.

In 310, the audio file, the advertising details and the advertising segment may be reviewed by the advertiser. This review may occur at a subsequent session from 284.

In 312, the server may publish the audio file along with the advertising segment over the network. For example, the audio file may be published via a Really Simple Syndication (RSS) 2.0 or Atom protocol. For example, publication may involve storing the audio file on the server, associating the audio file with a subscription, and sending the audio file out to subscribers associated with the subscription. Subscribers may subscribe to subscriptions, each subscriptions associated with at least one audio file and updated.

For example, the advertiser may be able to update or modify the advertising segment after it has been published. Updating or modifying the advertising segment may incur a new debit and credit transaction. For example, the advertisement segment may only be published with the audio file until an expiration condition is met. For example, an expiration condition may be a specified number of downloads or a specified period of time. Once the expiration condition is met, the advertising segment may be replaced by a second advertising segment. For example, the second advertising segment may be created by the advertiser or a second advertiser. For example, the systems depicted in FIGS. 1A and 1B may be configured to track a number downloads or requests of an audio file. For example, the number of downloads or requests of the audio file may be a factor in determining a second purchase price charged to the advertiser.

FIG. 3A illustrates an example screen shot of a log in screen, in accordance with an example embodiment of the present invention. For example, the log in screen may be generated by a server 100 and sent to a creator terminal 104 through a network 102 as depicted in FIG. 1A.

A plurality of fields may receive a log in information from a user. For example, the fields may be textboxes. The value of each textbox may be verified by the server.

Instructions 560 may be displayed to a user. Instructions 560 may be instructions on how to log in and what information is needed. Instructions 560 may also include a brief introductory message to the user.

An email textbox 562 may be provided. For example, the email textbox 562 may be configured to receive an email address or username from the user.

A password textbox 564 may be provided. For example, the password textbox 564 may be configured to receive a password from the user.

A login button 566 may be provided. For example, the login button 566 may submit the contents of the email textbox 562 and the password textbox 564 to the web server.

A send button 568 may be provided. For example, the send button 568 may submit the contents of the email textbox 562 to the web server for a lost password procedure. For example, the web server may email the password associated with the provided email address to the provided email address.

A register button 570 may be provided. For example, the register button 570 may receive an indication that a new user wishes to register and set up a new user's account on the web server.

FIG. 3B illustrates an example screen shot of a registration screen, in accordance with an example embodiment of the present invention. For example, the registration screen may be generated by a server 100 and sent to a creator terminal 104 through a network 102 as depicted in FIG. 1A.

A plurality of fields may receive a registration information from a user. For example, the fields may be textboxes. The value of each textbox may be verified by the server.

A first name textbox 300 may be provided. For example, the first name textbox 300 may be configured to receive a first name from a user.

A last name textbox 306 may be provided. For example, the last name textbox 306 may be configured to receive a last name from a user.

An email textbox 302 may be provided. For example, the email textbox 302 may be configured to receive an email address from the user. Alternatively, a user may be asked to choose a username. The server may then verify the username is not identical to an existing username. If the username is identical to an existing username, the user may be provided an opportunity to enter a replacement username.

A password textbox 308 may be provided. For example, the password textbox 308 may be configured to receive a password from the user. The server may enforce certain rules about passwords. For example, passwords may be required to be at least a given number of characters or be a mix of different types of characters.

A password verification textbox 304 may be provided. For example, the password inputted into the password textbox 308 may be inputted into the password verification textbox 304. The server may verify both passwords are identical.

An agreement to terms of use checkbox 310 may be provided. The user may check the agreement to terms of use checkbox 310 to indicate consent to agree to a terms of use. For example, the terms of use may be provided to the user on a separate page.

A register button 312 may be provided. For example, the register button 312 may submit the contents of the textboxes 300, 302, 304, 306, 308 and checkbox 310 to the web server, where a new user account is created.

FIG. 3C illustrates an example screen shot of a main menu screen, in accordance with an example embodiment of the present invention. For example, the main menu screen may be generated by a server 100 and sent to a creator terminal 104 through a network 102 as depicted in FIG. 1A.

A Produce Podshow button 320 may be provided. There may be a brief description of the Produce Podshow option proximal to the Produce Podshow button 320. The Produce Podshow button 320 may receive an indication from the user of a desire to produce a podshow.

A Publish Podshow button 322 may be provided. There may be a brief description of the Publish Podshow option proximal to the Publish Podshow button 322. The Publish Podshow button 322 may receive an indication from the user of a desire to publish a podshow over the network 102.

An Edit Podshow button 324 may be provided. There may be a brief description of the Edit Podshow option proximal to the Edit Podshow button 324. The Edit Podshow button 324 may receive an indication from the user of a desire to edit an existing podshow.

A Delete Podshow button 326 may be provided. There may be a brief description of the Delete Podshow option proximal to the Delete Podshow button 326. The Delete Podshow button 326 may receive an indication from the user of a desire to delete either a complete podshow or specific episodes of a podshow.

A View Podshow Statistics button 328 may be provided. There may be a brief description of the View Podshow Statistics option proximal to the View Podshow Statistics button 328. The View Podshow Statistics button 328may receive an indication from the user of a desire to view statistics regarding a podshow. For example, podshow statistics may include how many subscribers subscribe to the podshow.

FIG. 3D illustrates an example screen shot of a first screen of producing a podshow process, in accordance with an example embodiment of the present invention. For example, the screen may be generated by a server 100 and sent to a creator terminal 104 through a network 102 as depicted in FIG. 1A.

An icon 330 may indicate the current step in a process of producing a podshow. The icon 330 may also indicate the remaining steps of the process. In FIG. 3D, the user is on step one, copy/paste text, out of three steps.

A title 332 may indicate a title of the current step. For example, the step depicted in FIG. 3D is copy/paste text.

A textbox 334 may receive a text of a podshow to be created. For example, the text may be text for a producer to read aloud and record as an audio file. The server may enforce a word limit on the textbox 334. For example, the word limit may be 500 words.

A button 336 may receive a user's indication to submit text in the textbox 334 to the server and proceed to the next step of the process of producing a podshow.

FIG. 3E illustrates an example screen shot of a second screen of producing a podshow process, in accordance with an example embodiment of the present invention. For example, the screen may be generated by a server 100 and sent to a creator terminal 104 through a network 102 as depicted in FIG. 1A.

A plurality of input fields may receive information from a user. The value of input fields may be verified by the server.

An icon 340 may indicate the current step in a process of producing a podshow. The icon 340 may also indicate the remaining steps of the process. In FIG. 3E, the user is on step two, choose voice styles, out of three steps.

A title 342 may indicate a title of the current step. For example, the step depicted in FIG. 3E is choosing voice styles. For example, voice styles may be a set of characteristics to be associated with an audio file that will be created from the text received from the screen depicted in FIG. 3D. For example, the characteristics may be used to search a database of producers who may read the text received from the screen depicted in FIG. 3D.

A gender drop-down box 344 may be provided to receive a user's indication of a desired gender. A language drop-down box 346 may be provided to receive a user's indication of a desired language. An age drop-down box 348 may be provided to receive a user's indication of a desired age. A style drop-down box 350 may be provided to receive a user's indication of a desired reading style.

A search button 352 may receive a user's indication that all desired characteristics have been entered and that a search for appropriate producers may begin.

A results section 354 may be provided with voice styles matching the characteristics inputted by the user in the drop down boxes 344, 346, 348 and 350. The result section 354 may accept a user choice of a number of voice styles to read the text received from the screen depicted in FIG. 3D. For example, each voice style may be associated with a producer. For example, each voice style may include the characteristics associated with the voice style. For example, each voice style may include a sample that may be played by the user.

A button 356 may receive a user's indication of a desire to return to the previous step. For example, the previous step may be copy/paste text to be read. A button 358 may receive a user's indication of a desire to submit all inputs on the page to the server and proceed to the next step.

FIG. 3F illustrates an example screen shot of a third screen of producing a podshow process, in accordance with an example embodiment of the present invention. For example, the screen may be generated by a server 100 and sent to a creator terminal 104 through a network 102 as depicted in FIG. 1A.

A plurality of input fields may receive information from a user. The value of input fields may be verified by the server.

An icon 360 may indicate the current step in a process of producing a podshow. The icon 360 may also indicate the remaining steps of the process. In FIG. 3F, the user is on step three, review and publish podshow, out of three steps.

A title 362 may indicate a title of the current step. For example, the step depicted in FIG. 3F is to review and publish the podshow. In this step, a user may have the opportunity to review the audio file to be created and the characteristics associated with the audio file.

A text area 364 may contain the text received from the screen depicted in FIG. 3D. The user may review the text to ensure correctness.

A voice style selection area 366 may contain the voice styles selected by the user in FIG. 3E. The area 366 may display the voice styles selected by the user and the characteristics associated with the voice styles. The area 366 may include links to play samples of the voice styles selected by the user.

A special instructions textbox 368 may receive special instructions from the user. The server may enforce a word limit on a length of the text in the special instructions. A default text in the special instructions may be “No comment.”

A button 370 may receive a user's indication of a desire to return to the previous step. For example, the previous step may be choosing a voice style. A button 372 may receive a user's indication of a desire to submit all inputs on the page to the server and produce the audio file.

The text, voice styles and special instructions may be submitted to the server. The server may then transmit the information to a producer, who may produce an audio file based on the information.

FIG. 3G illustrates an example screen shot of a first screen of publishing a podshow process, in accordance with an example embodiment of the present invention. For example, the screen may be generated by a server 100 and sent to a creator terminal 104 through a network 102 as depicted in FIG. 1A.

A plurality of input fields may receive information from a user. The value of input fields may be verified by the server. FIG. 3G may receive a topic for an audio file to be published, whether the topic is to be created or selected from a provided list by a user.

An icon 374 may indicate the current step in a process of publishing a podshow. The icon 374 may also indicate the remaining steps of the process. In FIG. 3G, the user is on step one, create/select a topic, out of five steps.

A title 376 may indicate a title of the current step. For example, the step depicted in FIG. 3I is to create or select a topic.

A button 378 may allow a user to create a new topic to associate an audio file with.

A button 380 may allow the user to select an existing topic to associate the audio file with. If a user chooses to select an existing topic, the user may select the existing topic from a drop-down box 382 containing a list of existing topics.

A button 384 may receive a user's indication of a desire to submit all inputs on the page to the server and proceed to the next step.

FIG. 3I illustrates an example screen shot of a second screen of publishing a podshow process, in accordance with an example embodiment of the present invention. For example, the screen may be generated by a server 100 and sent to a creator terminal 104 through a network 102 as depicted in FIG. 1A.

A plurality of input fields may receive information from a user. The value of input fields may be verified by the server. FIG. 3I may be configured to receive information of a topic to be created by a user.

If the user selected to create a topic in FIG. 3G, FIG. 3I may be displayed to the user to collect the necessary information to create the topic. If the user selected an existing topic in FIG. 3G, the process may proceed to FIG. 3K.

An icon 390 may indicate the current step in a process of publishing a podshow. The icon 390 may also indicate the remaining steps of the process.

A title 392 may indicate a title of the current step. For example, the step depicted in FIG. 3I is to create a topic for the audio file. In this step, a user may enter information relevant to a topic being created for the audio file. In FIG. 3I, the user is on step two, inputting topic details, out of five steps.

Title textbox 394 may receive a user-inputted title for the topic.

Link textbox 396 may receive a user-inputted link for the topic. For example, the user-inputted link may be of a webpage that describes the topic.

Description textbox 398 may receive a user-inputted description for the topic. For example, the user-inputted description may describe the topic.

Advanced Options button 400 may display advanced options to be associated with the topic. FIG. 3I displays advanced options. iTunes® Option button 402 may display iTunes® options to be associated with the topic. If the iTunes® Option button 402 is selected, the screen shot depicted in FIG. 3J may be displayed.

Copyright textbox 404 may receive copyright information from the user.

Managing Editor textbox 406 may receive managing editor information from the user.

Web Master textbox 408 may receive web master information from the user.

Time to Live textbox 410 may receive time to live information from the user. For example, time to live information may be a period of time measured in months, weeks, days, hours or minutes. Time to life information may represent a period during which the audio file will remain published and available.

Select Image button 412 may receive an indication that the user wishes to associate an image with the audio file. For example, the user may enter a name of an image file to be transmitted to the server.

Categories selection 414 may receive a selected category associated with the audio file from the user. The selected category may be selected from a list of existing categories.

Alternatively, the user may input a new category into New Category text area 416.

A button 418 may receive a user's indication of a desire to return to the previous step. For example, the previous step may be creating/selecting a topic. A button 420 may receive a user's indication of a desire to submit all inputs on the page and proceed to the next step. For example, the next step may be creating/selecting an episode.

FIG. 3J illustrates an example screen shot of a second screen of publishing a podshow process, in accordance with an example embodiment of the present invention. For example, the screen may be generated by a server 100 and sent to a creator terminal 104 through a network 102 as depicted in FIG. 1A.

A plurality of input fields may receive information from a user. The value of input fields may be verified by the server. FIG. 3J receives information of a topic to be created by a user.

If the user selected to create a topic in FIG. 3G, FIG. 3J may be displayed to the user to collect the necessary information to create the topic. If the user selected an existing topic in FIG. 3G, the process may proceed to FIG. 3K.

An icon 430 may indicate the current step in a process of publishing a podshow. The icon 430 may also indicate the remaining steps of the process.

A title 432 may indicate a title of the current step. In this step, a user may enter information relevant to a topic being created for the audio file.

Title textbox 434 may receive a user-inputted title for the topic.

Link textbox 436 may receive a user-inputted link for the topic. For example, the user-inputted link may be of a webpage that describes the topic.

Description textbox 438 may receive a user-inputted description for the topic.

For example, the user-inputted description may describe the topic.

Advanced Options button 440 may display advanced options to be associated with the topic. For example, FIG. 3I displays advanced options. If the Advanced Options button 440 is selected, the screen shot depicted in FIG. 3I may be displayed. The iTunes® Option button 402 may display iTunes® options to be associated with the topic.

Owner Name textbox 444 may receive a user-inputted name of the owner or creator of the audio file.

Owner Email textbox 446 may receive a user-inputted email address of the owner or creator of the audio file.

Subtitle textbox 448 may receive a user-inputted subtitle to be associated with the audio file.

Keywords textbox 450 may receive a user-inputted set of keywords to be associated with the audio file.

Summary textbox 452 may receive a user-inputted summary to be associated with the audio file.

Block Podcast checkbox 454 may receive a user-inputted selection to block the audio file and other associated episodes from further publication.

Mark Podcast Explicit checkbox 456 may receive a user-inputted selection to mark the audio file as explicit content.

Select Image button 458 may receive an indication that the user wishes to associate an image with the audio file. For example, the user may enter a name of an image file to be transmitted to the server.

Main Category drop-down box 460 may receive a user-inputted selection of a main category to be associated with the audio file. For example, the main category may be selected from a list of existing main categories.

Sub Category drop-down box 462 may receive a user-inputted selection of a sub category to be associated with the audio file. For example, the sub category may be selected from a list of existing sub categories associated with the selected main category, where the selected main category is selected from the drop-down box 460.

A first button may receive a user's indication of a desire to return to the previous step. For example, the previous step may be creating/selecting a topic. A second button may receive a user's indication of a desire to submit all inputs on the page and proceed to the next step. For example, the next step may be creating/selecting an episode.

FIG. 3K illustrates an example screen shot of a third screen of publishing a podshow process, in accordance with an example embodiment of the present invention. For example, the screen may be generated by a server 100 and sent to a creator terminal 104 through a network 102 as depicted in FIG. 1A.

A plurality of input fields may receive information from a user. The value of input fields may be verified by the server. FIG. 3K may be configured to receive information of an episode to be associated with an audio file.

An icon 470 may indicate the current step in a process of publishing a podshow. The icon 470 may also indicate the remaining steps of the process.

A title 472 may indicate a title of the current step. For example, the step depicted in FIG. 3k is to create or select an episode to be associated with the audio file.

A Create New Episode button 474 may receive an indication that the user wishes to create a new episode.

A Select Episode button 476 may receive an indication that the user wishes to select an existing episode.

An Existing Episode drop-down box 478 may include a selection of existing episodes for the user to select. For example, the drop-down box 478 may be populated with a list of existing episodes after the user has selected button 476.

A button 480 may receive a user's indication of a desire to return to the previous step. For example, the previous step may be inputting topic details. A button 482 may receive a user's indication of a desire to submit all inputs on the page and proceed to the next step. For example, the next step may be entering details associated with the episode.

FIG. 3L illustrates an example screen shot of a fourth screen of publishing a podshow process, in accordance with an example embodiment of the present invention. For example, the screen may be generated by a server 100 and sent to a creator terminal 104 through a network 102 as depicted in FIG. 1A.

A plurality of input fields may receive information from a user. The value of input fields may be verified by the server. FIG. 3L may be configured to receive information of an episode to be created by a user.

If the user selected to create an episode in FIG. 3K, FIG. 3L may be displayed to the user to collect the necessary information to create the episode. If the user selected an existing episode in FIG. 3K, the process may proceed to FIG. 3N.

An icon 484 may indicate the current step in a process of publishing a podshow. The icon 484 may also indicate the remaining steps of the process.

A title 486 may indicate a title of the current step. For example, the step depicted in FIG. 3L is to create an episode for the audio file. In this step, a user may enter information relevant to an episode being created for the audio file.

Title textbox 488 may receive a user-inputted title for the audio file.

Audio File textbox 490 may receive a user-inputted file address for the audio file. For example, the audio file may be resident on the creator terminal or on the server.

Select Audio button 492 may receive a user-inputted selection to browse for the audio file. For example, the audio file may be resident on the creator terminal or on the server.

Advanced Options button 494 may receive a user-inputted selection to input advanced options associated with the audio file. For example, a screen as depicted in FIG. 3M may be displayed if a user selects to input advanced options associated with the audio file.

iTunes® Options button 496 may receive a user-inputted selection to input iTunes® options associated with the audio file. For example, a screen similar to one depicted in FIG. 3J may be displayed if a user selects to input iTunes ® options associated with the audio file. The screen may be similar to FIG. 3L but including the iTunes® options depicted in FIG. 3J.

A button 498 may receive a user's indication of a desire to return to the previous step. For example, the previous step may be creating/selecting an episode. A button 500 may receive a user's indication of a desire to submit all inputs on the page and proceed to the next step. For example, the next step may be previewing the information and publishing the audio file.

FIG. 3M illustrates an example screen shot of a fourth screen of publishing a podshow process, in accordance with an example embodiment of the present invention. For example, the screen may be generated by a server 100 and sent to a creator terminal 104 through a network 102 as depicted in FIG. 1A.

A plurality of input fields may receive information from a user. The value of input fields may be verified by the server. FIG. 3M may receive information of an episode to be created by a user. For example, the information received may include advanced options to be associated with an audio file.

If the user selected to create an episode in FIG. 3K, FIG. 3L may be displayed to the user to collect the necessary information to create the episode. If the user selected an existing episode in FIG. 3K, the process may proceed to FIG. 3N. The screen depicted in FIG. 3M may be configured to collected advanced options associated with the audio file. For example, the screen depicted in FIG. 3M may be displayed after a user selects to enter advanced options in a screen as displayed in FIG. 3L.

An icon 510 may indicate the current step in a process of publishing a podshow. The icon 510 may also indicate the remaining steps of the process.

A title 512 may indicate a title of the current step. For example, the step depicted in FIG. 3M is to create an episode for the audio file with additional input fields for advanced options to be associated with the episode.

Title textbox 514 may receive a user-inputted title for the title.

Audio File textbox 516 may receive a user-inputted file address for the audio file. For example, the audio file may be resident on the creator terminal or on the server.

Select Audio button 518 may receive a user-inputted selection to browse for the audio file. For example, the audio file may be resident on the creator terminal or on the server.

Advanced Options button 520 may receive a user-inputted selection to input advanced options associated with the audio file. For example, screen as depicted in FIG. 3M may be displayed if a user selects to input advanced options associated with the audio file.

iTunes® Options button 522 may receive a user-inputted selection to input iTunes® options associated with the audio file. For example, a screen similar to one depicted in FIG. 3J may be displayed if a user selects to input iTunes® options associated with the audio file. The screen may be similar to FIG. 3M but including the iTunes® options depicted in FIG. 3J.

Link textbox 524 may receive a user-inputted link or URL address for information on the episode.

Description textbox 526 may receive a user-inputted description for the episode.

Publication Date textbox 528 may receive a user-inputted publication date for the episode.

Author textbox 530 may receive a user-inputted author for the episode.

Available Categories selection box 532 may receive a user-inputted category for the episode.

Your Categories textbox 534 may receive a user-inputted user-selected category for the episode.

A first button may receive a user's indication of a desire to return to the previous step. For example, the previous step may be creating/selecting an episode. A second button may receive a user's indication of a desire to submit all inputs on the page and proceed to the next step. For example, the next step may be previewing the information and publishing the audio file.

FIG. 3N illustrates an example screen shot of a fifth screen of publishing a podshow process, in accordance with an example embodiment of the present invention. For example, the screen may be generated by a server 100 and sent to a creator terminal 104 through a network 102 as depicted in FIG. 1A.

A plurality of input fields may receive information from a user. The value of input fields may be verified by the server. The screen depicted in FIG. 3N may present details of the audio file to be published for a user's review. The screen depicted in FIG. 3N may receive an indication from the user to publish the audio file.

An icon 540 may indicate the current step in a process of publishing a podshow. The icon 540 may also indicate the remaining steps of the process.

A title 542 may indicate a title of the current step. For example, the step depicted in FIG. 3N is to preview and publish the audio file.

Information 544 may be displayed to the user. The information 544 may be details of inputs previously inputted by the user in the process of publishing a podshow. The user may review the information 544 to check for correctness.

A button may receive a user's indication of a desire to publish the audio file as previewed in FIG. 3N. For example, the server may publish the audio file in RSS 2.0 or Atom format after receiving the indication to publish the audio file.

FIG. 3O illustrates an example screen shot of a confirmation screen of publishing a podshow process, in accordance with an example embodiment of the present invention. For example, the screen may be generated by a server 100 and sent to a creator terminal 104 through a network 102 as depicted in FIG. 1A.

A URL textbox 546 may display a Universal Resource Locator (URL) address where listeners on the network may subscribe to the podshow.

A Javascript textbox 548 may display a Javascript script to be added to a Hypertext Markup Language (HTML) webpage to allow listeners on the network to subscribe to the podshow.

A Play button 550 may incorporate the Javascript script displayed in the textbox 548 and display a sample button. The button 550 may allow the user to test the script and listen to the newly published audio file.

A Link 552 may allow the user to begin the process again and publish another audio file.

It will be appreciate that the term “audio file” as used in this specification may be replaced by any multimedia file. For example, a video file or live streaming feed may be used. For example, the streaming feed may be either video or audio. For example, other digital files may be used such as three dimensional modeling files, graphics and images, made available to users in a subscription format.

Several embodiments of the present invention are specifically illustrated and described herein. However, it will be appreciated that modifications and variations of the present invention are covered by the above teachings and within the purview of the appended claims without departing from the spirit and intended scope of the invention.

We claim:

1. A method for network audio distribution, comprising:
providing a list of characteristics for an audio file to be created to a creator;
receiving text of the audio file from the creator;
receiving an indication of a selection of characteristics for the audio file from the creator, the selection of characteristics selected from the list of characteristics; and
transmitting the text and the selection of characteristics to a producer.

2. A method of claim 1, further comprising:
receiving the audio file from the producer;
notifying the creator that the audio file is ready; and
storing the audio file on a web-accessible queue.

3. A method of claim 1, wherein the selection of characteristics includes at least one of a reading style, a voice gender, and a language or dialect for the audio file.

4. A method of claim 1, further comprising:
providing a set of available categories for the audio file to be created to the creator; and
receiving a set of categories associated with the audio file from the creator, the set of categories associated with the audio file selected from the set of available categories.

5. A method of claim 1, further comprising:
receiving a creator identification information from the creator.

6. A method of claim 1, wherein the network is the Internet.

7. A method of claim 1, further comprising:
providing a list of available audio files to an advertiser;
receiving an indication of an advertiser-selected audio file, wherein the advertiser-selected audio file is selected from the list of available audio files;
receiving an indication of a set of advertising details from the advertiser;
associating the set of advertising details with the advertiser-selected audio file; and
publishing the advertiser-selected audio file over a network.

8. A method of claim 7, wherein the set of advertising details includes a purchase price and an advertisement segment, the advertisement segment to be published with the advertiser-selected audio file.

9. A method of claim 7, wherein the set of advertising details includes a bid and an advertisement segment, the advertisement segment to be published with the advertiser-selected audio file.

10. A method of claim 7, wherein publishing the advertiser-selected audio file over the network further includes,
associating the advertiser-selected audio file with a subscription,
receiving an indication of a subscription selection from a subscriber, the subscription selection selected from a list of available subscriptions, and
providing the advertiser-selected audio file associated with the subscription selection to the subscriber on a recurring basis.

11. A method of claim 7, further comprising
producing the advertisement segment.

12. A method of claim 1, further comprising:
receiving an indication of a set of advertising details from an advertiser;
selecting an advertising audio file;
providing an indication of the advertising audio file;
associating the set of advertising details with the advertising audio file; and
publishing the advertising audio file over a network.

13. A method of claim 12, wherein the advertising details includes,
an advertisement segment,
an advertisement segment name, and
a set of advertiser-selected criteria of an acceptable audio file to be associated with the advertisement segment.

14. A method of claim 12, wherein the selecting the advertising audio file is executed by the creator.

15. A method of claim 12, wherein the publishing the advertising audio file further comprises,
debiting the advertiser for a first amount of credit; and
crediting the creator for a second amount of credit.

16. A method of claim 12, wherein the publishing the advertising audio file further comprises,
responsive to a specified event, debiting the advertiser for a third amount of credit; and
crediting the creator for a fourth amount of credit.

17. A method for network audio distribution, comprising:
providing text of an audio file to a server; and
providing an indication of a selection of characteristics for the audio file to the server.

18. A method of claim 17, wherein the network is the Internet.

19. A method of claim 17, further comprising:
publishing the audio file on the server.

20. A method of claim 19, wherein the audio file is published in a RSS 2.0 format.

21. A method of claim 17, further comprising:
receiving an audio file corresponding to the text and the selection of characteristics.

22. A method of claim 21, wherein the audio file is received from a web-accessible queue.

23. A method for network audio distribution, comprising:
receiving a text and an indication of a selection of characteristics selected by a creator from a server; and
creating an audio file corresponding to the text and the selection of characteristics.

24. A method of claim 23, wherein the text and the indication of the selection of characteristics is received via email.

25. A method of claim 23, further comprising:
storing the audio file on a web-accessible queue.

26. A method of claim 23, further comprising:
sending a notification that the audio file is available.

27. An apparatus for network audio distribution, comprising:
a network interface, the network interface in communications with a network; and
a processor the processor operably connected to the network interface and configured to,
provide a list of characteristics for an audio file to be created to a creator,
receive a text of the audio file from the creator,
receive an indication of a selection of characteristics for the audio file from the creator, and
transmit the text and the selection of characteristics to a producer.

28. An apparatus for network audio distribution, comprising:
a network interface, the network interface in communications with a network; and
a processor the processor operably connected to the network interface and configured to,
provide a list of characteristics for an audio file to be created to a creator,
receive a text of the audio file from the creator,
receive an indication of a selection of characteristics for the audio file from the creator,
transmit the text and the selection of characteristics to a producer,
provide a list of available audio files to an advertiser,
receive an indication of an advertiser-selected audio file, wherein the advertiser-selected audio file is selected from the list of available audio files,
receive a set of advertising details from the advertiser,
associate the set of advertising details with the advertiser-selected audio file, and
publish the advertiser-selected audio file over a network.

29. An apparatus for network audio distribution, comprising:
a network interface, the network interface in communications with a network; and
a processor the processor operably connected to the network interface and configured to,
provide a list of characteristics for an audio file to be created to a creator,
receive a text of the audio file from the creator,
receive an indication of a selection of characteristics for the audio file from the creator,
transmit the text and the selection of characteristics to a producer,
receive an indication of a set of advertising details from an advertiser,
select an advertising audio file,
provide an indication of the advertising audio file,
associate the set of advertising details with the advertising audio file, and
publish the advertising audio file over a network.

30. A method for network multimedia distribution, comprising:
providing a list of characteristics for an multimedia file to be created to a creator;
receiving a content description of the multimedia file from the creator;
receiving an indication of a selection of characteristics for the multimedia file from the creator;
transmitting the content description and the selection of characteristics to a producer;
providing a list of available multimedia files to an advertiser;
receiving an indication of an advertiser-selected multimedia file, wherein the advertiser-selected multimedia file is selected from the list of available multimedia files;
receiving an indication of a set of advertising details from the advertiser;
associating the set of advertising details with the advertiser-selected multimedia file; and
publishing the advertiser-selected multimedia file over a network, wherein publishing further includes,
associating the advertiser-selected multimedia file with a subscription,
receiving an indication of a subscription selection from a subscriber, the subscription selection selected from a list of available subscriptions, and
providing the advertiser-selected multimedia file associated with the subscription selection to the subscriber on a recurring basis.
